(19) United States
(12) Patent Application Publication
(10) Pub. No.: US 2014/0269359 A1
(43) Pub. Date: Sep. 18, 2014

(54) REDUCTION OF RETRANSMISSION LATENCY BY COMBINING PACING AND FORWARD ERROR CORRECTION

(71) Applicant: Google Inc., Mountain View, CA (US)

(72) Inventors: James A. Roskind, Redwood City, CA (US); Raman Tenneti, Los Altos, CA (US)

(21) Appl. No.: 13/829,469

(22) Filed: Mar. 14, 2013

(51) Int. Cl. H04J 1/16

(52) U.S. Cl. CPC H04L 43/0882
USPC 370/252

(57) ABSTRACT

A computer-implemented method for reducing retransmission latency, including steps for determining a packet transmission interval for a plurality of data packets, determining redundant error correction information for the plurality of packets and pacing a transmission of the plurality of packets to a recipient, wherein each of the plurality of packets is separated in time based on the packet transmission interval. In certain aspects, the method further includes steps for transmitting the redundant error correction information to the recipient once each of the plurality of packets has been transmitted. Systems and computer-readable media are also provided.

### BACKGROUND

The disclosed subject matter provides methods and systems for reducing retransmission latency for data packets transmitted over a network. More specifically, the subject disclosure provides ways to reduce retransmission latency by implementing a combination of packet pacing (“pacing”) and forward error correction (FEC).

In some network systems, packet latency has two major contributors: serialization latency that results from bandwidth limitations, and retransmission latency, that results from packet loss. As network transmission speeds increase, delay contributions from serialization latency decrease. As such, retransmission latency is increasingly the dominant contributor to network delays.

### SUMMARY

The disclosed subject matter relates to a computer-implemented method for reducing retransmission latency, including, determining a packet transmission interval for a plurality of data packets, determining redundant error correction information for the plurality of packets and pacing a transmission of the plurality of packets to a recipient, wherein each of the plurality of packets is separated in time based on the packet transmission interval. In certain aspects, the method can further include transmitting the redundant error correction information to the recipient once each of the plurality of packets has been transmitted.

The disclosed subject matter also relates to a system for reducing retransmission latency, including one or more processors and a computer-readable medium including instructions stored therein, which when executed by the processors, cause the processors to perform operations including determining a packet transmission interval for a plurality of data packets, determining redundant error correction information for the plurality of packets based on a XOR sum of the plurality of data packets and pacing a transmission of the plurality of packets to a recipient, wherein each of the plurality of packets is separated in time based on the packet transmission interval. In certain aspects, the processors can further perform operations for transmitting the redundant error correction information to the recipient once each of the plurality of packets has been transmitted.

In yet another aspect, the subject technology relates to a computer-readable medium including instructions stored therein, which when executed by a processor, cause the processor to perform operations including determining a packet transmission interval for a plurality of data packets, determining redundant error correction information for the plurality of packets and pacing a transmission of the plurality of packets to a recipient, wherein each of the plurality of packets is separated in time based on the packet transmission interval. In certain aspects, the processors can further perform operations for transmitting the redundant error correction information to the recipient once each of the plurality of packets has been transmitted.

It is understood that other configurations of the subject technology will become readily apparent from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a block diagram of a network system in which retransmission packet loss can occur, according to certain aspects of the subject disclosure.

FIG. 2 illustrates a block diagram of a network system in which pacing and forward error correction are implemented, according to certain aspects of the subject technology.

FIG. 3 illustrates an example process for implementing pacing and forward error correction, according to certain aspects of the subject technology.

FIG. 4 illustrates an example network system that can be used to implement some aspects of the subject technology.

FIG. 5 illustrates an example of an electronic system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these specific details. In some instances, structures and components are shown in block diagram form in order to avoid obscuring the concepts of the subject technology.

FIG. 1 conceptually illustrates a block diagram of network system 100 in which retransmission packet loss has occurred. Network system 100 includes sender 102 with sender buffer 103, intermediary 104 with intermediary buffer 105, and receiver 106.

Sender 102, intermediary 104 and/or receiver 106 can represent various types of devices configured to send and/or receive data packets via a communication network, such as the Internet. Although the example of FIG. 1 illustrates network system 100 as including only three devices (e.g., sender 102, intermediary 104 and receiver 106), it is understood that a greater number of devices may be included in network system 100. For example, multiple devices (e.g., routers, switches, servers, personal computers and/or mobile devices) can be included in network system 100 and/or exist on the communication path between sender 102 and receiver 106.

As illustrated, data packets (e.g., packet A, packet B and packet C) sent from sender 102 are received by intermediary 104 and retransmitted to receiver 106. In certain implementations, the data packets are temporarily stored in sender buffer 103, before being transmitted to receiver 106. While en route to receiver 106, the packets are received by intermediary 104 and temporarily stored in intermediary buffer 105. As shown, additional memory space exists in sender buffer 103, however, intermediary buffer 105 has reached its maximum fill level and cannot accept additional data. Consequently, data packets received by intermediary 104 that cannot be stored into intermediary buffer 105, are dropped. By way of example, packet A is successfully stored in intermediary buffer 105 and transmitted by intermediary 104 to receiver 106; however, packet B and packet C (which exceed the immediate capacity of intermediary buffer 105), are dropped. Accordingly, the dropped packets (e.g., packet B and packet C) need to be retransmitted by sender 102 to receiver 106.

The delay associated with the retransmission of packets B and C is referred to as a “retransmission delay.” In certain aspects, the probability of intermediary 104 dropping packet B is related to with the probability of dropping packet C. For example, if intermediary buffer 105 is full upon the arrival of packet B, there is an increased probability that it is still full (at an instant later), when packet C arrives. In such instances, the packet loss probability (as between packet B and packet C) is said to be “correlated.”

As discussed above, delays associated with packet loss can sometimes be reduced through the use of forward error correction (FEC) techniques, where the recipient is provided with redundant error correction information that can be used to reconstruct lost packets (e.g., packets B and C). By way of example, with proper error correction information, receiver 106 could reconstruct re-construct the contents of packet B and packet C, thus avoiding the need for retransmission. However, in certain implementations, FEC techniques are less effective when packet loss is highly correlated because where packet loss occurs, the likelihood of lost error correction information is also increased. For example, the loss of packet C would indicate an increased likelihood of losing FEC information sent from sender 102 to receiver 106 following packet C.

In some cases, delays associated with correlated packet loss can be mitigated by de-correlating packet transmissions. One method for de-correlating packet transmissions is to pace packet transmissions such that a transmission interval (e.g., a packet transmission interval) is introduced between packets in the data stream. By introducing a transmission interval between packets, intermediary buffers (e.g., intermediary buffer 105) can be given a greater time period to free memory resources that can be used to store subsequently received packets.

The transmission interval introduced between multiple packets may vary depending on implementation. In certain aspects, the transmission interval may be set at a fixed and predetermined time period. However, in certain implementations the transmission interval can be based on one or more dynamic network characteristics, such as bandwidth availability and/or packet size. By way of further example, a packet transmission interval may be based on one or more network characteristics, such as measures of currently available dedicated resources for one or more devices in the network (e.g., intermediary 104).

FIG. 2 illustrates a block diagram of a network system in which pacing and FEC are implemented, according to certain aspects of the technology. The network system of FIG. 2 includes first computer 202, second computer 204 and network 206. As illustrated, network 206 is shown to transmit multiple data packets, such as packet A, packet B, packet C and error correction packet 207. It is understood that network 206 is a simplified illustration of a communication network (e.g., the Internet) and that one or more devices (e.g., processor based devices such as computers, routers, servers and/or switches, etc.) may be included in the communication path of network 206, between first computer 202 and second computer 204.

Error correction packet 207 can include error correction information for one or more packets that have been exchanged between first computer 202 and second computer 204. In the example illustrated in FIG. 2, error correction packet 207 includes error correction information for packet A, packet B and packet C, that are en route to second computer 204 from first computer 202. The actual error correction information included in error correction packet 207 can depend on implementation, as well as the error correction code or algorithm used for data reconstruction. By way of example, second computer 204 may be configured to perform error correction using one or more logic operations including an “exclusive or” (e.g., “XOR”) operation. As such, error correction packet 207 can include XOR error correction information for each of packet A, packet B and packet C.

It is understood that aspects of the technology can be implemented using other algorithms or error correction codes. By way of example, more complex error correction codes, such as “Fountain Codes,” raptor codes,” or “online codes” may be used. Using a Fountain Code implementation, N packets of data can be protected by sending K error correction packets. In such implementations, the successful arrival of any N of the N+K packets can enable the N data packets to be recovered.

Information contained in error correction packet 207 can enable a receiving device, such as second computer 204, to reconstruct data lost for one or more packets dropped in transmission. The amount of original information needed to perform error correction for one or more dropped packets can vary depending on implementation. By way of example, if packet B were dropped during transmission so that second computer 204 only received packet A, packet C, and error correction packet 207, the information contents of packet B could be recovered, based at least in part on the information contained in packet A, packet C and error correction packet 207. By recovering the contents of dropped packet B (rather than having first computer 202 retransmit packet B to second computer 204), the retransmission latency for data sent between first computer 202 and second computer 204 can be improved (e.g., decreased).

As further illustrated in the example of FIG. 2, each of the data packets sent from first computer 202 to second computer 204 are separated by time interval T. As discussed above, a pacing interval T used to separate packet transmission may be constant or dynamic, and can be based on a variety of factors including network parameters, such as, bandwidth availability and/or available buffer/memory resources. As such, the actual duration of T can vary by implementation, for example, from a few milliseconds to several seconds. Furthermore, in certain aspects, time interval T will be set such that transmission occurs at a rate that is less than a maximum transmission rate of the transmitter/sender (e.g., sender 102 or first computer 202).

In some implementations, a desired pacing time interval T may be approximated by achieving an average pacing interval T. For example, if a desired inter-packet time interval is 500 microseconds, then a similar average time interval may be achieved by sending 2 packets in 1 millisecond, or 4 packets in 2 milliseconds. Depending on implementation, the precise inter-packet transmission times can vary and still achieve a desired average interval over a series of packets. For example, to achieve a desired average inter-packet spacing of 500 microseconds between packets, a sender can send 2 packets in a first millisecond, none in the second millisecond, and then 4 packets in the third millisecond (for a total of 6 packets across a 3 millisecond period), thereby achieving the desired average inter-packet pacing rate of 500 microseconds.

As discussed above, retransmission latency can be mitigated using either packet pacing or FEC techniques. Pacing involves the planned transmission of packets at evenly spaced time intervals and is generally more effective at reducing buffer-exhaustion induced packet loss (e.g., which includes correlated packet loss due to ongoing buffer exhaustion). In contrast, FEC is generally best suited for network scenarios wherein few packets get dropped, allowing a recipient to reconstruct dropped packets using redundant error correction information. However, FEC (when implemented alone) can be less effective if too many packets are dropped to enable the recipient to recover the dropped packets using the error correction information. Specifically, FEC is less effective in reducing retransmission latency for correlated (bursty) packet loss, where the error correction information has been constructed from information contained in lost packets.

In certain aspects of the subject technology, a combination of FEC and pacing can be used to improve (reduce) retransmission latency by a greater amount than the separate contributions from packet pacing and FEC combined. That is, FEC when combined with packet pacing, can yield synergistic improvements toward the reduction of retransmission latency.

In some implementations, pacing enhances the benefits provided by FEC. By way of example, without pacing, the probability of loss for packet A, packet B, packet C, or error correction packet 207 may be highly correlated, inducing a burst loss commonly when there is any loss, and precluding error recovery. In contrast, with pacing close to the available drain rate of an intermediate buffer, the loss of a single packet (e.g., one of packet A, packet B, packet C, or error correction packet 207), may actually diminish the probability of a second packet from the sequence being lost, and increase the probability that error correction recovery can be performed. Thus, by using pacing to de-correlate two or more packets in a transmission stream, the effectiveness of FEC can be improved, for example, by increasing the likelihood that enough original data is received to perform data recovery for dropped packets, while also reducing the probability that error correction information (e.g., error correction packet 207) gets dropped.

A method for implementing a combination of pacing and FEC techniques is described with respect to an example process 300 illustrated in FIG. 3. Specifically, process 300 begins with step 302 in which a packet transmission interval for a plurality of data packets is determined. The determination of the packet transmission interval may be based on a variety of parameters or network characteristics, and therefore can depend on implementation. The packet transmission interval may be based on, but not is not limited to, various network characteristics such as available bandwidth, current computing resources (e.g., memory or processing resources for one or more computers, servers, routers, etc. in the transmission path), and packet size.

In certain implementations, the packet transmission interval is dynamic and will change over time, for example, with respect to changes in network characteristics, such as bandwidth availability. As such, depending on implementation, the transmission interval between any two packets in a data stream may be the same, or may be different.

In some aspects, bandwidth availability can be estimated by observing packet receptions. For example, if multiple packets are sent with minimal inter-packet spacing (e.g., without any pacing), then the inter-packet arrival times may be an estimate of the link bandwidth, for example, at the most restrictive section of the communication path. As another example, if more than one packet is sent with inter-packet pacing corresponding to the aforementioned link bandwidth estimate (e.g., a paced inter-packet send interval approximating the aforementioned link bandwidth inter-arrival interval), then the resulting inter-arrival interval may be used to estimate available bandwidth along the communication path.

In step 304, redundant error correction information is determined for the plurality of packets. As discussed above, error correction information can be a function of the data contents of the packets for which the error correction information is generated, as well as the error correction process or algorithm used to recover missing information (e.g., dropped packets). Although various error correction algorithms can be used to reconstruct missing data (e.g., using the error correction information), in certain implementations an XOR operation can be used to reconstruct missing data. As such, the error correction information can include XOR information for the data contents of one or more of the plurality of packets. By way of example, if the plurality of packets includes packet A, packet B and packet C, discussed above with respect to FIG. 2, error correction information can include XOR information for the data contents of packet A, packet B and packet C.

In step 306, a transmission of the plurality of packets to a recipient is paced, wherein each of the plurality of packets is separated in time, based on the packet transmission interval. In some implementations, the temporal separation between transmitted packets may be approximately equal; however, in certain implementations the separation between packets can vary, for example, depending on network conditions.

In step 308, redundant error correction information is transmitted to the recipient. Although redundant error correction information can be transmitted for known quantities of data at any time, in certain aspects, the error correction information is transmitted to the recipient after transmission of each of the plurality of packets has occurred. Further to the example of FIG. 2, redundant error correction information (e.g., information included in error correction packet 207) can be transmitted to second computer 204 after packet A, packet B and packet C have been transmitted. In some implementations, a plurality of error correction packets may be transmitted in conjunction with, or following, a plurality of data packets. For example, a fountain code can be used to accommodate N packets, followed by K error correction packets, such that the receipt of any N of the K+N packets would facilitate the recovery of all N data packets.

As discussed above, by de-correlating packet loss, pacing of the transmission of the plurality of packets can increase a recovery probability for one or more of the plurality of packets using the redundant error correction information. In this way, data transmission methods that utilize both pacing and error correction techniques can more significantly reduce retransmission latency, than using either technique alone. Furthermore, it should be appreciated that in certain implementations using a combination of pacing and FEC techniques together can provide a greater reduction is retransmission latency than the combined benefit of each technique when implemented in isolation.

FIG. 4 illustrates an example network system that can be used to implement some aspects of the subject technology. Specifically, network system 400 includes first user device 402, second user device 404, third user device 406 and server 410. As illustrated, first user device 402, second user device 404 and third user device 406 are communicatively connected to server 410, via network 408. It is understood that in addition to first user device 402, second user device 404, third user device 406 and server 410, any number of other processor-based devices could be communicatively connected to network 408. Furthermore, as will be discussed in greater detail below, network 408 could comprise multiple networks, such as a network of networks, e.g., the Internet.

In some examples, one or more of the process steps of the subject technology can be carried out by one or more of first user device 402, second user device 404, third user device 406 and/or server 410. By way of example, any of the user devices (e.g., first user device 402, second user device 404 and/or third user device 406) may be configured to transmit packets using a process of the subject technology, including determining a packet transmission interval for a plurality of data packets, determining redundant error correction information for the plurality of packets and pacing a transmission of the plurality of packets to a recipient (such as server 410), wherein each of the plurality of packets is separated in time based on the packet transmission interval. In certain aspects, the user devices may be configured to transmit the redundant error correction information to the recipient (e.g., server 410) once each of the plurality of packets has been transmitted.

FIG. 5 illustrates an example of an electronic system 500 that can be used for executing the steps of the subject disclosure. In some examples, electronic system 500 can be a single computing device such as a user device (e.g., any one of first user device 402, second user device 404 or third user device 406) or a server (e.g., server 410). Furthermore, in some implementations, electronic system 500 can be operated alone or together with one or more other electronic systems e.g., as part of a cluster or a network of computers.

As illustrated, electronic system 500 includes storage 502, system memory 504, display device 506, bus 508, ROM 510, processor(s) 512, input/output device interface 514 and network interface 516. In some aspects, bus 508 collectively represents all system, peripheral, and chipset buses that communicatively connect the numerous internal devices of electronic system 500. For instance, bus 508 communicatively connects processor(s) 512 with ROM 510, system memory 504, display device 506 and storage 502.

In some implementations, processor(s) 512 retrieve instructions to execute (and data to process) in order to execute the steps of the subject technology. Processor(s) 512 can be a single processor or a multi-core processor in different implementations. Additionally, processor(s) 512 can comprise one or more graphics processing units (GPUs) and/or one or more decoders, depending on implementation.

ROM 510 stores static data and instructions required by processor(s) 512 and other modules of electronic system 500. Similarly, processor(s) 512 can include one or more memory locations such as a CPU cache or processor in memory (PIM), etc. In some implementations, storage device 502 can be a read-and-write memory device. In some aspects, this device can be a non-volatile memory unit that stores instructions and data even when electronic system 500 is without power. Some implementations of the subject disclosure can use a mass-storage device (such as solid state, magnetic or optical storage devices) e.g., storage 502.

Other implementations can use one or more a removable storage devices (e.g., magnetic or solid state drives) such as storage 502. Although system memory 504 can be either volatile or non-volatile, in some examples system memory 504 is a volatile read-and-write memory, such as a random access memory. System memory 504 can store some of the instructions and data that processor(s) 512 need at runtime.

Code for implementing processes of the subject technology can be stored in system memory 504, storage device 502, ROM 510 and/or one or more memory locations embedded with processor(s) 512. From these various memory units, processor(s) 512 can retrieve instructions to execute and data to process in order to execute the processes of some implementations of the instant disclosure.

Bus 508 also connects to input/output device interface 514 and display device 506. Input/output device interface 514 enables a user to communicate information and select commands to electronic system 500. Input devices used with input/output device interface 514 can include, for example, alphanumeric keyboards and pointing devices (also called “cursor control devices”) and/or wireless devices such as wireless keyboards, wireless pointing devices, etc.

Finally, as shown in FIG. 5, bus 508 also communicatively couples electronic system 500 to a network (not shown) through network interface 516. It should be understood that network interface 516 can be either wired, optical or wireless and may comprise one or more antennas and transceivers. In this manner, electronic system 500 can be a part of a network of computers, such as a local area network (“LAN”), a wide area network (“WAN”), or a network of networks, such as the Internet (e.g., network 408, as discussed above).

In practice the methods of the subject technology can be carried out by electronic system 500. In some aspects, instructions for performing one or more processes of the present disclosure are stored on one or more memory devices such as storage 502 and/or system memory 504.

By way of example, electronic system 500 could be configured (e.g., using processor(s) 512) to perform operations for determining a packet transmission interval for a plurality of data packets wherein the packet transmission interval is larger than a minimal interval supported on a transmitter's outbound link, determining redundant error correction information for the plurality of packets based on a XOR sum of the plurality of data packets and pacing a transmission of the plurality of packets to a recipient, wherein each of the plurality of packets is separated in time based on the packet transmission interval. In certain aspects, electronic system 500 can be further configured to transmit the redundant error correction information (e.g., using network interface 516) to the recipient once each of the plurality of packets has been transmitted.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A method for reducing retransmission latency, comprising:
determining a packet transmission interval for a plurality of data packets;
determining redundant error correction information for the plurality of packets;
pacing a transmission of the plurality of packets to a recipient, wherein each of the plurality of packets is separated in time based on the packet transmission interval; and
transmitting the redundant error correction information to the recipient once each of the plurality of packets has been transmitted.

2. The method of claim 1, wherein pacing the transmission of the plurality of packets increases a recovery probability for one or more of the plurality of packets, using the redundant error correction information.

3. The method of claim 1, wherein pacing the transmission of the plurality of packets decreases a correlation in packet loss between two or more of the plurality of packets.

4. The method of claim 1, wherein determining the packet transmission interval further comprises:
estimating an available network bandwidth,
wherein the packet transmission interval is based on the estimated available network bandwidth.

5. The method of claim 1, further comprising:
updating the packet transmission interval based on changes in available network bandwidth.

6. The method of claim 1, wherein the packet transmission interval is larger than a minimal interval supported on a transmitter's outbound link.

7. The method of claim 1, wherein the redundant error correction information is based on a XOR sum of the plurality of data packets.

8. A system for reducing retransmission latency, comprising:
one or more processors; and
a computer-readable medium comprising instructions stored therein, which when executed by the processors, cause the processors to perform operations comprising:
determining a packet transmission interval for a plurality of data packets;
determining redundant error correction information for the plurality of packets based on a XOR sum of the plurality of data packets;
pacing a transmission of the plurality of packets to a recipient, wherein each of the plurality of packets is separated in time based on the packet transmission interval; and
transmitting the redundant error correction information to the recipient once each of the plurality of packets has been transmitted.

9. The system of claim 8, wherein pacing the transmission of the plurality of packets increases a recovery probability for one or more of the plurality of packets, using the redundant error correction information.

10. The system of claim 8, wherein pacing the transmission of the plurality of packets decreases a correlation in packet loss between two or more of the plurality of packets.

11. The system of claim 8, wherein determining the packet transmission interval further comprises:
estimating an available network bandwidth,
wherein the packet transmission interval is based on the estimated available network bandwidth.

12. The system of claim 8, further comprising:
updating the packet transmission interval based on changes in available network bandwidth.

13. The system of claim 8, wherein the packet transmission interval is larger than a minimal interval supported on a transmitter's outbound link.

14. A computer-readable storage medium comprising instructions stored therein, which when executed by a processor, cause the processor to perform operations comprising:
determining a packet transmission interval for a plurality of data packets;
determining redundant error correction information for the plurality of packets;
pacing a transmission of the plurality of packets to a recipient, wherein each of the plurality of packets is separated in time based on the packet transmission interval; and
transmitting the redundant error correction information to the recipient.

15. The computer-readable storage medium of claim 14, wherein pacing the transmission of the plurality of packets increases a probability of recoverability for one or more of the plurality of packets using the redundant error correction information.

16. The computer-readable storage medium of claim 14, wherein pacing the transmission of the plurality of packets decreases a correlation in packet loss between two or more of the plurality of packets.

17. The computer-readable storage medium of claim 14, wherein determining the packet transmission interval further comprises:
estimating an available network bandwidth,
wherein the packet transmission interval is based on the estimated available network bandwidth.

18. The computer-readable storage medium of claim 14, further comprising:
updating the packet transmission interval based on changes in available network bandwidth.

19. The computer-readable storage medium of claim 14, wherein the packet transmission interval is larger than a minimal interval supported on a transmitter's outbound link.

20. The computer-readable storage medium of claim 14, wherein the redundant error correction information is based on a XOR sum of the plurality of data packets.
